(19) United States
(12) Patent Application Publication
(10) Pub. No.: US 2012/0091055 A1
(43) Pub. Date: Apr. 19, 2012

(54) Filter Device for Cleaning of Water Polluted with Solid Particles and/or Dissolved Pollutants

(75) Inventors: Jorge Torras-Pique, Bad Uberkingen-Hausen (DE); Carsten Dierkes, Munster (DE)

(73) Assignees: H2O RESEARCH GMBH, Munster (DE); 3P TECHNIK FILTERSYSTEME GMBH, Donzdorf (DE)

(21) Appl. No.: 13/375,072

(22) PCT Filed: Jun. 2, 2010
(86) PCT No.: PCT/EP10/03358

§ 371 Date: Dec. 20, 2011

(30) Foreign Application Priority Data
Jun. 5, 2009 (DE) DE102009024003.9

(51) Int. Cl. C02F 1/42

(52) U.S. Cl. 210/264

(57) ABSTRACT

The invention relates to a filter device for cleaning water polluted with solid particles and/or dissolved pollutants, particularly surface water from streets or roof runoffs, comprising a housing (12), which has at least one inlet (13) for polluted water and at least one outlet (14) arranged upstream of the inlet (13) for cleaned water, wherein in the housing (12) in a flow direction (20) of the water a filter unit (16) is arranged between the inlet (13) and the outlet (14), through which filter unit the water to be cleaned flows in the upstream direction, and wherein the filter unit (16) comprises an ion exchanger. The ion exchanger is designed as a synthetic molecular sieve (17).

The invention relates to a filter device for the cleaning of water polluted with solid particles and/or dissolved pollutants, in particular surface water from highway or roof runoffs, with a housing which has at least one inlet for polluted water and at least one outlet for cleaned water provided above the inlet, wherein there is mounted in the housing between the inlet and the outlet a filter unit through which the water to be cleaned flows upwards, and wherein the filter unit contains an ion exchanger.

Filter devices for the cleaning of polluted surface water have been known for a long time. The surface water is generally rain water flowing off sealed surfaces. Such sealed surfaces are for example road surfaces, parking areas, or runways and taxiways at airports, which are heavily frequented by vehicles of all kinds. Through brake and tyre wear and the emission of catalysts, a range of pollutants, in particular heavy metals , oils and polyaromatic hydrocarbons, are washed along with the flowing rainwater. Another problem area is that of roofs, in particular metal roofs, where the rainwater flowing off includes especially heavy metals, which are then present in hydrated form as heavy metal ions. Such water, contaminated by solid particles and/or dissolved pollutants, may not on account of various regulations, for example test values of the German Federal Soil Protection and Contaminated Sites Orders, be allowed to soak into the subsoil without prior cleaning, or be made available for further use, for example as industrial water.

A filter device for the cleaning of such polluted water is known for example from DE 10 2004 042 390 A1. The filter device described there is in the form of a manhole fitting and has plates of several segments forming a hollow space, which is provided for the insertion of an ion exchanger. The ion exchanger used here is a natural zeolite, in particular klinoptilolith, chabasit or phillipsit. In respect of heavy metals, however, natural zeolites have only moderate sorption capacity, so that especially in the case of heavily polluted water an unsatisfactory cleaning effect is obtained.

The problem of the invention is to create a filter device of the type referred to above which, in comparison with the known filter devices, gives better cleaning results in the cleaning of water polluted by solids and/or dissolved pollutants.

This problem is solved by a filter device with the features of the independent claim 1. Developments of the invention are put forward in the dependent claims.

The filter device according to the invention is characterised in that the ion exchanger is in the form of a synthetic molecular sieve.

A synthetic molecular sieve of this kind is characterised by a defined gap width or pore size, which may be set optimally for the heavy metal ions to be adsorbed. In cases of heavy rainfall, the water is only briefly in contact with the filter medium. In the case of natural zeolites, this short contact time is insufficient to obtain satisfactory cleaning results, due to the uneven and sharply varying gap widths. In terms of pore structure, synthetic molecular sieves or synthetic zeolites are very much more regular than natural zeolites. The synthetic molecular sieves therefore have a distinctly higher sorption capacity in respect of heavy metal ions, leading to a very much better cleaning result.

In an especially preferred manner, the synthetic molecular sieve is provided as fill made of regularly shaped zeolite grains. The regular shape of the zeolite grains provides a much larger surface for adsorption of the dissolved pollutants than is available from natural zeolites. Natural zeolites are generally a mixture of zeolite grains of quite different particle sizes. Fill of this kind made of natural zeolites also has a high proportion of undersize, which is of no practical use for cleaning water, but means that the fill is relatively tightly packed and consequently has a high weight. Fill comprised of regularly shaped zeolite grains of synthetic zeolite is in comparison much more loosely packed and therefore has a much lower weight. Moreover, the flow resistance of the regularly shaped zeolite grains of the synthetic molecular sieve is much lower than that of the irregularly shaped zeolite grains of the natural zeolite. This means that the loss of pressure with a synthetic molecular sieve in the form of fill is less, and the filter device may be operated without a pump.

Especially preferred is for the zeolite grains to be spherical in shape. It is however also possible for cylindrical zeolite grains to be used. Also, in principle, a mixture of spherical and cylindrical zeolite grains would be possible.

In a development of the invention, the zeolite grains have a grain size of 0.5 mm to 10.0 mm, in particular 1.5 mm to 8.0 mm.

In an especially preferred manner, the fill of the synthetic molecular sieve has several fill layers, one above the other in the direction of flow, each with a defined grain size distribution, in particular zeolite grains of substantially the same grain size, with the grain size reducing in the flow direction from one fill layer to the next. It is therefore possible to obtain several consecutive filtration stages, which may be set for example quite specifically for a particular dissolved pollutant, in particular a specific dissolved heavy metal ion.

Expediently the grain size in the lowest fill layer lies in the range between 4.0 mm and 6.0 mm, in particular around 5.0 mm, while the grain size of the layer lying above in the direction of flow is in the range from 2.0 mm to 3.0 mm, in particular approximately 2.5 mm.

In an especially preferred manner, the synthetic molecular sieve is selected from the group comprising zeolite type A, zeolite type X, zeolite type Y, zeolite type L, synthetic mordenite and zeolite type ZSM-5.

Used in one development of the invention is a zeolite type X which has a pore width of 5 angstrom (5X) to 20 angstrom (20X), preferably 10 angstrom (10X) to 15 angstrom (15X), in particular 13 angstrom (13X). By selecting zeolite grains of a suitable gap width, for example 13 angstrom, it is possible to set the adsorption effect quite optimally for the particular pollutants to be adsorbed, in particular heavy metal ions.

In a development of the invention, in the case of a synthetic molecular sieve comprised of several fill layers, all fill layers are made of zeolite of type X, with the grain size of the type X zeolite grains reducing from one fill layer to the next. Alternatively it is possible for at least one fill layer, in particular the first fill layer in the direction of flow, to comprise zeolite type X, and for at least one other fill layer to be made up of one other zeolite type from the group comprising zeolite type A, zeolite type Y, zeolite type L, synthetic mordenite and zeolite type ZSM-5. In the case of a synthetic molecular sieve made up of several fill layers it is therefore possible by choosing different types of zeolite to provide further scope for variation in order to obtain an optimal cleaning effect.

In an especially preferred manner, the filter unit has an activated carbon layer. Whereas the synthetic molecular sieve mainly filters heavy metal ions and nitrates from the polluted or contaminated water, the activated carbon layer cleans the polluted water of hydrocarbons present in it, such as mineral oils and polycyclic, aromatic hydrocarbons.

Expediently the activated carbon layer is provided downstream of the synthetic molecular sieve in the direction of flow. Preferably the activated carbon layer is made up of a fill of activated coke.

In a development of the invention, the housing has an interior containing a lower chamber equipped with the inlet and an upper chamber equipped with the outlet, while the filter unit separates the two chambers as a defined water-permeable partition.

The filter unit may be in the form of a filter cartridge which may be replaced if necessary.

In an especially preferred form, the filter cartridge is comprised of several filter elements arranged next to one another, for example in the form of cylinder sectors. As compared with known modular filter units this has the advantage that the filter elements, relative to the cross-section of the housing at its upper opening, are comparatively small, so that maintenance of the filter unit or of individual filter elements, or their replacement, may be effected more easily and cost-effectively.

Expediently a coarse screen, in particular a slotted screen, is provided upstream of the synthetic molecular sieve in the direction of flow. This coarse screen serves for the filtering of coarse particles or other solids.

Expediently a fine screen is provided upstream of the outlet in the direction of flow. This prevents the zeolite grains and/or the activated carbon fill from being carried away into the outlet by the flowing water.

In a development of the invention, the housing is made at least partly of plastic material, preferably polyolefin material, in particular polyethylene material.

In an especially preferred manner there is provided in the flow direction upstream of the molecular sieve a distribution chamber for polluted water, extending substantially over an entire inflow surface of the molecular sieve. This ensures an even inflow to the molecular sieve, substantially over its complete inflow surface.

Preferred embodiments of the invention are shown in the drawing and explained in detail below. The drawing shows in:

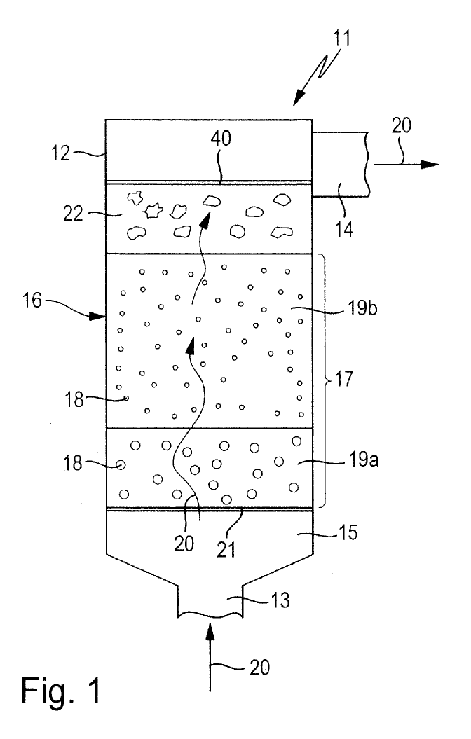

FIG. 1 a schematic layout of a first embodiment of the filter device according to the invention

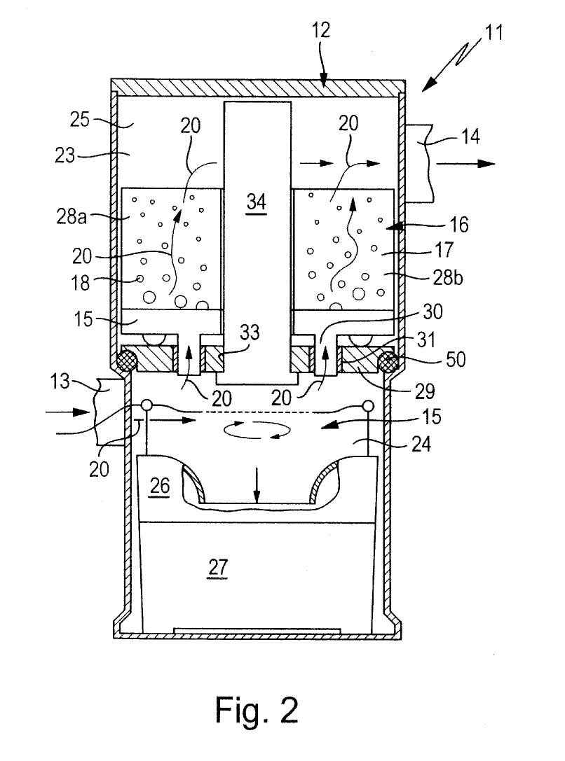

FIG. 2 a longitudinal section through a second embodiment of the filter device according to the invention

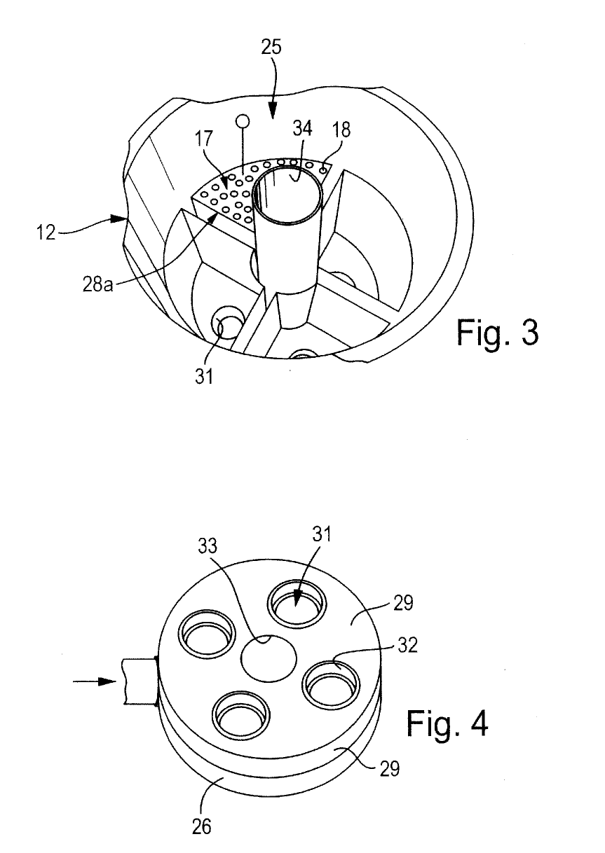

FIG. 3 a perspective top view of one of the filter elements of the filter device according to FIG. 2

FIG. 4 a component of the filter unit of FIG. 2, and

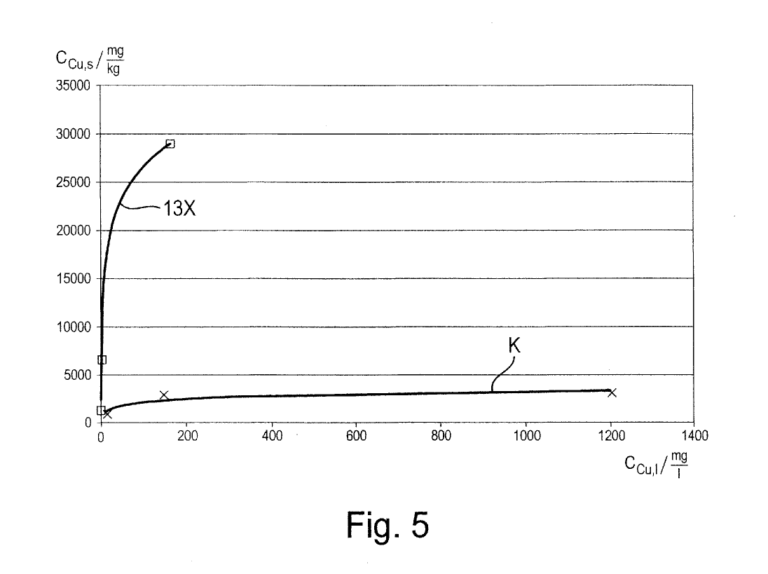

FIG. 5 a comparison of the sorption capacities of a synthetic molecular sieve with a natural zeolite.

FIG. 1 shows a first embodiment of the filter device 11 according to the invention for the cleaning of water polluted with solid particles and/or dissolved pollutants. The water concerned is surface water, for example rainwater running off from sealed surfaces, for example road surfaces or roofs. This flowing water is contaminated by various solid particles and dissolved pollutants; it washes products of brake and tyre wear and catalyser particles away from road surfaces and carries them along with it. Nutrients such as phosphates or nitrates are also frequently washed away. Water running off metal roofs is contaminated by heavy metals, which may include lead, copper, zinc and cadmium.

The filter device 11 according to the invention is suitable for cleaning the contaminated water of these pollutants, so that it may subsequently soak into the subsoil or be reused as industrial water.

The filter device has a housing 12 with at least one inlet 13 for polluted water and at least one outlet 14 for cleaned water arranged above the inlet 13. According to the first embodiment, the inlet 13 is in the form of a tubular pipe stub provided on the base of the housing 12. The housing 12 is made of weather-resistant rigid plastic material, in particular polyethylene. The inlet 13 opens out into a distribution chamber 15 for the inflowing polluted water. The distribution chamber 15 extends over approximately the whole inflow surface of the synthetic molecular sieve 17, thereby ensuring an even flow on to the molecular sieve. Mounted in the flow direction 20 between the inlet 13 and the outlet 14 is a filter unit 16, through which the water to be cleaned flows upwards. The filter unit 16 is sealed towards the inside wall of the housing, to prevent any transverse flows bypassing the filter unit 16 and therefore not being cleaned.

The filter unit 16 has an ion exchanger in the form of a synthetic molecular sieve 17. The synthetic molecular sieve 17 is provided as fill made up of regularly shaped zeolite grains 18, for example spherical. By way of example, a zeolite of type X is used here. This has a gap width or pore width of 10 angstrom (10X) to 15 angstrom (15X). The grain size of the zeolite grains 18 lies in the range from 1.5 mm to 8.00 mm.

As shown by way of example in FIG. 1, the fill has several fill layers 19a, 19b, one above the other in the flow direction 20 and each having zeolite grains 18 of substantially the same grain size, with the grain size reducing in the flow direction 20 from fill layer 19a to fill layer 19b. Also provided upstream of the lowest fill layer 19a in the flow direction 20 is a coarse screen 21 which screens out coarse particles or other solids, for example leaves or branches which have been washed along by the water.

The grain size of the zeolite grains 18 in the lowest fill layer amounts for example to approximately 5.0 mm, whereas the grain size of the fill layer 19b lying above in the flow direction 20 is for example approximately 2.5 mm. According to the first embodiment, both the lowest fill layer 19a and the fill layer 19b lying above are comprised of zeolite type X with substantially round grains. It is however also possible for the upper of the two fill layers 19a, 19b to be comprised of a different zeolite type, chosen for example from the group consisting of zeolite type A, zeolite type X, zeolite type Y, zeolite type L, synthetic mordenite and zeolite type ZSM-5. The fill layers 19a, 19b may for example be separated from one another by an intermediate screen (not shown).

Above the uppermost fill layer 19b there is also an activated carbon layer 22 made up of activated coke fill. The activated carbon layer 22 is used to filter hydrocarbons out of the polluted water.

The filtration involves firstly the guiding of polluted water via suitable pipework to the inlet 13 of the filter device 11. The polluted water enters the filter housing 12, where it is distributed in the distribution chamber 15. Coarse particles and other solids are retained by the coarse screen. The polluted water flows through the filter unit in the flow direction 20 from bottom to top, i.e. in an upwards flow, with the polluted water passing first into the lowest fill layer 19a of the synthetic molecular sieve 17. In this lowest fill layer 19b, heavy metals and nitrates are separated out. The synthetic molecular sieve 17 operates here as an ion exchanger. This involves the heavy metal ions dissolved in the water being replaced by ions contained in the zeolite matrix, with the heavy metal ions then being taken up into the matrix through adsorption. In the lowest fill layer 19b, for example, a zeolite of type 13X is used, with a pore diameter of 13 angstrom. By this means it is possible to separate molecules of approximately the same size out of the polluted water. Here the heavy metal ions are not in a free state, but instead are hydrated, i.e. surrounded by a certain number of water molecules, which help determine the size of the molecule to be separated. In the fill layer 19b lying above, a zeolite for example of the same type i.e. type X is used, but here the pore size is smaller, lying for example in the range of around 8 angstrom, so that here smaller molecules may be separated out.

After the polluted water has flowed through the synthetic molecular sieve 17 it passes into the activated carbon layer 22 in which hydrocarbons, in particular mineral oils, are separated out. The now cleaned water then passes to the outlet 14 from where it soaks into the subsoil, or is fed to alternative downstream units, e.g. a cistern.

FIG. 5 shows a comparison of the sorption capacities of, on the one hand, a synthetic molecular sieve of type 13X, and on the other hand a natural zeolites of the type klinoptilolith. Copper has been chosen as an example of the ion to be taken up, originating for example from rainwater flowing off copper roofs. The diagram in FIG. 5 shows as the x-axis the copper (Cu) concentration in solution (Ccu, I) and as y-axis the copper (Cu) concentration in the solid phase (Ccu,s). It therefore shows the copper concentration in the solid phase as a function of the copper concentration in solution. As the diagram clearly shows, the sorption curve K of the natural zeolite klinoptilolith is relatively flat, with a copper concentration in the solid phase of around a maximum of approximately 3,500 mg/kg being reached. In comparison with this, the sorption curve 13X of the synthetic molecular sieve 17 has a much steeper course and here, with a copper concentration in solution of 200 mg/l, a copper concentration in the solid phase of approximately 28,000 mg/kg is achieved. In comparison with this, at this copper concentration in solution, the natural zeolite reaches just 2,500 mg/kg. The sorption capacity of the synthetic molecular sieve 17 is therefore around ten times greater than the sorption capacity of the natural zeolite. The separation of heavy metal ions from polluted water is therefore significantly more effective with a synthetic molecular sieve 17 than with a natural zeolite. This depends above all on the large inner surface of the synthetic molecular sieve, which in addition may have a standard pore diameter for each fill layer. The natural zeolites on the other hand are a mixture of zeolite grains of quite different pore diameters, so that the kinetics of the ion exchanger are here very much less effective.

FIG. 2 shows a second embodiment of the filter device 11 according to the invention. The filter device 11 has a housing 12 with an interior 23 divided into a lower chamber 24 and an upper chamber 25, while the filter unit 16 serves as a defined water-permeable partition between the lower and upper chambers 24, 25. The inlet 13 is here guided on to the side of the housing 12 and is in a preferred manner similarly in the form of a pipe stub. The water intake is effected here at a tangent to the inner wall of the housing 12, with this tangential introduction of the water generating a hydro-cyclone, leading to a forced separation of coarse solid particles. Beneath the inlet 13 is a sinkhole 26 connected to a sediment collector 27 in which the coarse solid particles settle. In the flow direction 20 between the inlet 13 and the outlet 14 there is in turn a filter unit 16, made in several modular sections. The filter unit 16 is comprised of several adjacent filter elements, of which only two filter elements 28a, 28b are shown in FIG. 2. As shown in particular in FIG. 3, the filter elements 28a, 28b are in the form of cylinder sectors. Each of these cylinder sectors then contains a synthetic molecular sieve 17, for example in the form of the fill shown in FIG. 1.

As shown by way of example in FIG. 4, there is provided a blocking element 29 which on the one hand is sealed against the inside wall of the housing by a seal 50, for example a ring seal, and on the other hand carries the cylinder-sector-like filter elements 28a, 28b. At the same time each of the filter elements 28a, 28b has a tubular inlet pipe stub 30 which is inserted through an opening 31 in the blocking element 29. In the opening 31 is a further seal element 32 which encompasses the inlet pipe stub, thereby ensuring a sealing effect. Finally a central opening 33 is also provided, through which is guided a hollow column 34 extending from the lower to the upper chamber, passing through the upper chamber 25, and opening out outside the housing 12. The hollow column 34 serves for overflow, in the event of an extremely heavy inflow of polluted water. Moreover, with a suitable suction hose , the sediment collector 27 may be reached via the hollow column 34.

Provided here too is a distribution chamber 15, positioned upstream of the molecular sieve 17 in the direction of flow and extending roughly over the whole inflow surface of the molecular sieve 17, thereby ensuring an even inflow on to the molecular sieve 17. Expediently the inlet pipe stubs 30 lead into the distribution chamber 15.

As referred to above, the filter unit 16 of the second embodiment of the filter device according to the invention also contains a synthetic molecular sieve, so that with regard to the nature of the separation of heavy metal ions and where applicable nitrates, reference is made to the first embodiment described above. Expediently here too each of the filter elements 28a, 28b has an activated carbon layer 22.

1. A filter device for the cleaning of water polluted with solid particles and/or dissolved pollutants, in particular surface water from highway or roof runoffs, the filter device comprising a housing which has at least one inlet for polluted water and at least one outlet for cleaned water provided above the inlet, wherein there is mounted in the housing in a flow direction of the water between the inlet and the outlet a filter unit through which the water to be cleaned flows upwards, and wherein the filter unit contains an ion exchanger, and wherein the ion exchanger is a synthetic molecular sieve.

2. A filter device according to claim 1, wherein the synthetic molecular sieve is provided as fill made of regularly shaped zeolite grains.

3. A filter device according to claim 2, wherein the zeolite grains are spherical in shape.

4. A filter device according to claim 2, wherein the zeolite grains have a grain size of 1.5 mm to 8.0 mm.

5. A filter device according to claim 2, wherein the fill comprises several fill layers, one above the other in the direction of flow, each with zeolite grains of substantially the same grain size, with the grain size reducing in the flow direction from fill layer to fill layer.

6. A filter device according to claim 5, wherein the grain size in the lowest fill layer lies in the range between 4.0 mm and 6.0 mm, while the grain size of the layer lying above in the direction of flow is in the range from 2.0 mm to 3.0 mm.

7. A filter device according to claim 1, wherein the synthetic molecular sieve is selected from the group comprising zeolite type A, zeolite type X, zeolite type Y, zeolite type L, synthetic mordenite and zeolite type ZSM-5.

8. A filter device according to claim 7, wherein a zeolite type X which has a pore width of 5 angstrom (5X) to 20 angstrom (20X), is used.

9. A filter device according to claim 5, wherein in the case of a synthetic molecular sieve comprised of several fill layers, all fill layers are made of zeolite of type X, with the grain size of the type X zeolite grains reducing from fill layer to fill layer or that the first fill layer in the direction of flow is comprised of zeolite type X and at least one other fill layer is made up of one other zeolite type from the group comprising zeolite type A, zeolite type Y, zeolite type L, synthetic mordenite and zeolite type ZSM-5.

10. A filter device according to claim 1, wherein the filter unit has an activated carbon layer, wherein the activated carbon layer is provided downstream of the synthetic molecular sieve in the direction of flow.

11. A filter device according to claim 1, wherein the housing has an interior containing a lower chamber equipped with the inlet and an upper chamber equipped with the outlet, while the filter unit separates the two chambers as a defined water-permeable partition.

12. A filter device according to claim 1, wherein the filter unit is a filter cartridge which may be replaced if necessary and is comprised of several filter elements arranged next to one another, wherein the filter elements are cylinder sectors.

13. A filter device according to claim 1, wherein a coarse screen is provided upstream of the synthetic molecular sieve in the direction of flow.

14. A filter device according to claim 1, wherein a fine screen is provided upstream of the outlet in the direction of flow.

15. A filter device according to claim 1, wherein there is provided in the flow direction upstream of the molecular sieve a distribution chamber for polluted water, extending substantially over an entire inflow surface.
